(19) United States
(12) Patent Application Publication
(10) Pub. No.: US 2009/0279720 A1
(43) Pub. Date: Nov. 12, 2009

(54) SPEAKER

(76) Inventors: Hee Jin Kim, Daegu (KR); Young In Ko, Gyeongsang-bukdo (KR)

Correspondence Address: KED & ASSOCIATES, LLP, P.O. Box 221200, Chantilly, VA, 20153-1200, US

(21) Appl. No.: 12/304,475

(22) PCT Filed: Jan. 4, 2007
(86) PCT No.: PCT/KR07/00050

§ 371 Date: Dec. 12, 2008

(51) Int. Cl. H04R 1/00

(52) U.S. Cl. 381/191

(57) ABSTRACT

A speaker is disclosed. A speaker includes a fixing part (500) fastened to a base frame; a motion part (400) moved with respect to the fixing part by an electromagnetic force; a vibration plate (200) that vibrates in communication with the motion part; and an area enlargement part (202) provided on the vibration plate to enlarge an effective area of the vibration plate. Therefore, according to the present invention, a speaker capable of reproducing a high quality sound and high power with a slim design may be embodies.

### TECHNICAL FIELD

The present invention relates to a speaker, and more particularly, to a speaker adaptable to a display apparatus such as a TV, a computer monitor and the like.

### BACKGROUND ART

Generally, a speaker converts electrical signals to vibration of a vibration plate and creates waves in the air to generate an acoustic wave. That is, a speaker is a kind of a conversion device which converts electrical signals to an acoustic energy. A speaker includes vibration parts such as a vibration plate, support parts such as a damper, magnetic parts such as a magnet. A speaker may be classified into various categories based on a vibration plate position, a vibration plate shape, a principle/method for converting electrical signals to acoustic waves and the like. Especially, a speaker adapted to a display apparatus such as TV and the like is usually a radiation type speaker having a vibration plate positioned in the air. In the radiation type speaker, electric currents corresponding to acoustic signals are flowing in a coil provided in a magnetic field formed by a magnet and then the coil vibrates based on the intensity of electric currents, which is a common principle of a speaker operation.

Recently, a large screen display apparatus has been used broadly due to development of a semiconductor technology. To present a beautiful and simple design of such a large screen display apparatus as a FPD (Flat Panel Display), a speaker has to be small and slim. If a speaker is small, inner parts such as a vibration part, magnet part and support part should be small, as well. However, if a speaker is small, functions of a speaker may deteriorate. This is due to deterioration of sound radiation efficiency caused by reduction of a vibration part, especially effective vibration area, flux density reduction caused by a magnetic part and so on. However, in spite of the small size of the speaker, the speaker for a large screen display apparatus is required to have the same as or better function than a conventional speaker.

In a speaker adapted to a FPD, it is not relatively easy to adjust a width and thickness of the speaker, while it is relatively easy to adjust a width and thickness of the speaker. Thus, it is general to reduce the width/thickness and increase the length, in order not to reduce an effective vibration area. That is, a speaker having a rectangular or an oval shape with a short width and long length (hereinafter, a track type speaker) is used not to reduce an effective vibration area. That is, the speaker for a FPD has a high ratio of a long diameter to a short diameter, or a ratio of the length to the width of a speaker.

Referring to FIGS. 1 and 2, a conventional trade type speaker will be described.

A speaker 3 includes an energy conversion part 40 and 50 that converts an electrical energy (an electrical signal) to a kinetic energy, and a vibration plate 20 that converts the kinetic energy generated at the energy conversion part 40 and 50 to an acoustic energy.

The energy conversion part 40 and 50 includes a fixing part 50 and a motion part 40 relatively moved with respect to the fixing part 50 by an electromagnetic force. The vibration plate 20 is connected to the motion part 40 to reproduce a sound by using the vibration of the vibration plate 20.

More specifically, the fixing part 50 is provided at a predetermined portion of a base frame 70. The fixing part 50 includes a permanent magnet 56. Commonly, an upper plate 52 and a lower plate 54 are provided on an upper portion and lower portion of the permanent magnet 56, respectively to concentrate a magnetic flux generated at the permanent magnet 56 there between. The motion part 40 is generally called as a voice coil assembly, which includes a bobbin 42 having a cylindrical shape and a voice coil 44 wound around the bobbin 42. The vibration plate 20 is connected to the bobbin 42. A center cap 29 is provided on a center of the vibration plate 20. The numeral reference 34 is a gasket.

A lower portion of the bobbin 42 is elastically connected to the base frame 70 by a damper 60. The vibration plate 20 is connected to an upper portion of the bobbin 42 and an outer end of the vibration plate 20 is connected to the base frame 70 by an elastic support part 30 (hereinafter, an edge). The damper 60 and the edge 30 are kinds of the supporting parts, which supports the vibration part including the voice coil 44, the bobbin 42 and the vibration plate 20 in their appropriate position to perform a vertical motion, in other words, a piston motion. Also, the damper 42 and the vibration plate 20 affects reproduction of high power and high quality sound.

As mentioned above, the track type speaker 3 is shaped with a narrow width and a long length. The vibration plate 20 has a large ratio of a length to a width. However, the section of the bobbin 42 has a circular shape. Also, the shape of the damper corresponds to the shape of the bobbin and thus is circular, more specifically, annular. As shown in FIG. 3, the damper 60 elastically supporting the bobbin 42 has a ring shape and is repeatedly curved a predetermined distance in a circumferential direction from a hollow part 61. That is, the damper 60 has a plurality of wrinkle parts 61a in approximately concentric circle shape.

Referring to FIG. 2, an operation of the track type speaker will be described as follows.

Once electric currents are applied to the voice coil 44, an inductive force is generated at the coil within the magnetic field of the permanent magnet 56. Hence, the voice coil 44 moves vertically and the bobbin 42 connected to the voice coil 44 moves vertically. Accordingly, the vibration plate 20 coupled to the bobbin 42 also vertically moves in communication with the vertical motion of the voice coil 44, which is an upward/downward piston motion. That is, the vibration plate 20 vibrates forwardly/backwardly in communication with the voice coil 44 and the bobbin 42 to vibrate air, such that acoustic waves may be generated. The sound applied to the voice coil 44 as an electrical signal is substantially reproduced by the vibration of the vibration plate 20 to radiate outside of the speaker.

### DISCLOSURE OF INVENTION

### Technical Problem

The conventional track type speaker described above has following problems.

First, the conventional track type speaker has a problem that it is limited to enlarge its effective vibration area due to its structure. Moreover, the width of the conventional track type speaker is reduced and thus the sizes of voice coil and damper are also reduced. Thus, it is difficult for the conventional track type speaker to endure the inputted high voltage. As a result, it is difficult to achieve high quality sound and high power.

Next, according to the conventional track type speaker, the width of the vibration plate is smaller than the length of the vibration plate. Not the whole portion of the vibration plate, the center of the vibration plate is supported by the damper. Thereby, there may be unbalanced vibration in a longitudinal direction. Also, the vibration plate may be unbalancedly supported by the voice coil and the damper. Accordingly, resonance of the vibration may be generated which might distort reproduced sound due to a non-linear motion of the vibration parts. Still further, there may be a strange sound or damage of the parts due to the mechanical friction.

### Technical Solution

An object of the present invention is to provide a speaker which can be slim with preventing sound reproduction deterioration

To achieve these objects and other advantages and in accordance with the purpose of the invention, as embodied and broadly described herein, a speaker includes a fixing part fastened to a base frame; a motion part moved with respect to the fixing part by an electromagnetic force; a vibration plate that vibrates in communication with the motion part; and an area enlargement part provided on the vibration plate to enlarge an effective area of the vibration plate. The area enlargement part may be configured with at least one of a concave part and a convex part.

The vibration plate may be formed in a track shape and the shape of the motion part corresponds to the shape of the vibration plate.

A fastening part may be provided in a back portion of the vibration plate to be fastened to the motion part. The fastening part may be provided at an edge of the vibration plate.

In another aspect of the present invention, a speaker includes a fixing part fixed to a base frame; a motion part moved with respect to the fixing part by an electromagnetic force; a vibration plate that vibrates in communication with the motion part; and a fastening part provided in a back portion of the vibration plate to be fastened to the motion part.

The vibration plate is formed in a track shape and the shape of the motion part may be corresponding to the shape of the vibration plate.

The fastening part may be provided an edge of the vibration plate. The fastening part may be partially provided at the edge of the vibration plate. Also, the fastening part may be fastened to at least one of an outer surface and an inner surface of the motion part.

### ADVANTAGEOUS EFFECTS

A speaker according to the present invention has an advantageous effect that it is possible to present a high quality sound/high power with a slim design.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a front view of a conventional track type speaker;

FIG. 2 is a sectional view of FIG. 1;

FIG. 3 is a plane view illustrating a damper of FIG. 1;

FIG. 4 is an exploded perspective view illustrating an embodiment of a track type speaker according to the present invention;

FIGS. 5 and 6 are perspective views illustrating a vibration plate of FIG. 4, more specifically FIG. 5 is a perspective view seen from an upper portion and FIG. 6 is a perspective view seen from a lower portion; and

FIG. 7 is a sectional view of FIG. 4.

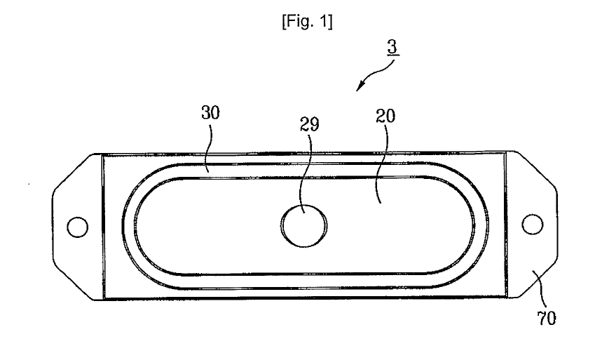

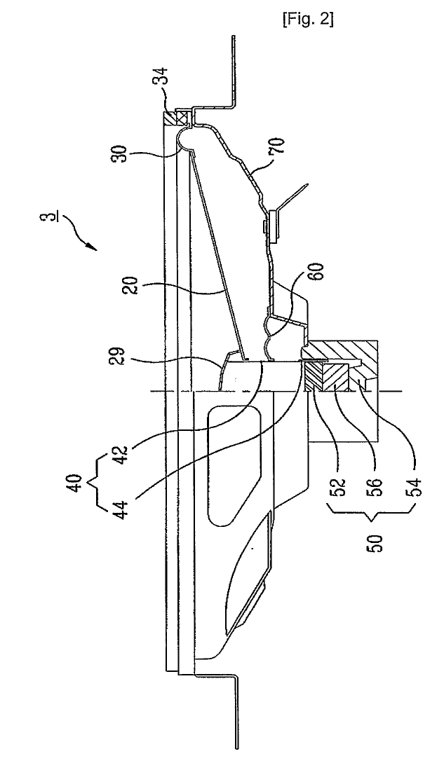

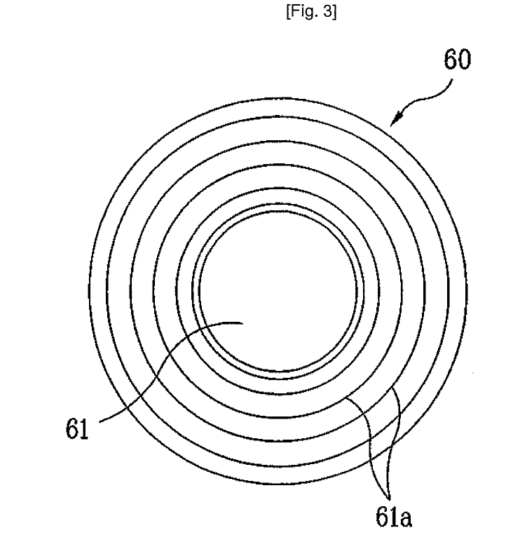

### BEST MODE FOR CARRYING OUT THE INVENTION

Reference will now be made in detail to the preferred embodiments of the present invention, examples of which are illustrated in the accompanying drawings.

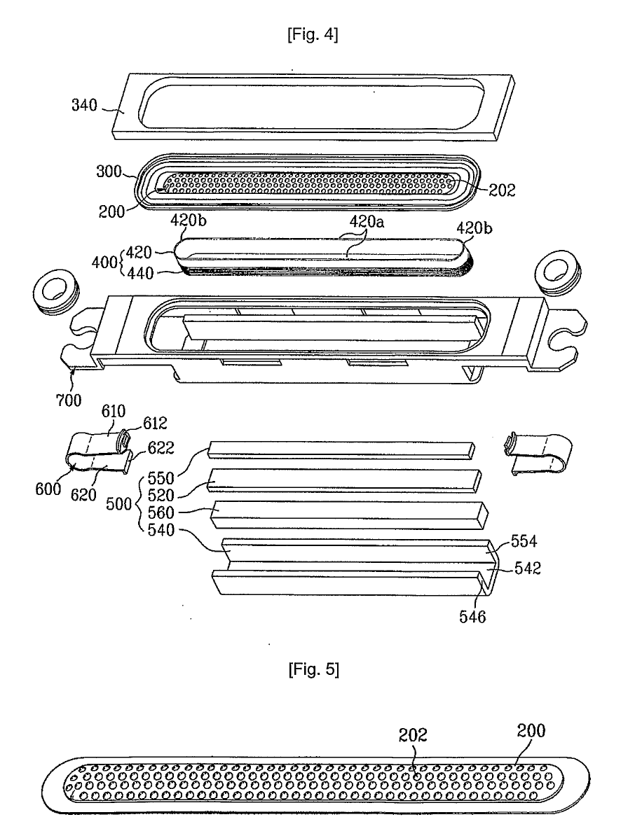

Referring to FIG. 4, a preferred embodiment of a speaker according to the present invention will be described.

Similar to the prior art, the speaker according to the present invention includes an energy conversion part 400 and 500, and a vibration plate 200. The fixing part 500 includes a permanent magnet 560. Preferably, the fixing part 500 further includes an upper plate 520 and a lower plate 540. Also, an auxiliary magnet 550 may be provided in the fixing part 500 for concentrating the magnetic force. The motion part 400 includes a bobbin 420 and a voice coil 440. The bobbin 420 is supported by a damper 600 and the vibration plate 200 is supported by an edge 300.

According to the present invention, an area enlargement part 202 is provided on the vibration plate 200 to enlarge an effective area of the vibration plate 200. Comparing with a vibration plate without the area enlargement part 202, the effective area is enlarged in the vibration plate 200 with the enlargement part 202. The area enlargement part 202 may be configured with at least one of a concave part and a convex part, although not limited thereto.

Even though the area enlargement part 202 may be provided on a circular vibration plate, it is preferred that the area enlargement part 202 is provided on a track shaped vibration plate 200. This is because the track type speaker has limitation of installation space and its track shaped vibration plate 200 has also such limitation, although the effective area of the track shaped vibration plate 200 is at least the same or larger than that of the circular shaped vibration plate. Thus, it is preferred that the area enlargement part 202 is provided to enlarge the effective area of the track shaped vibration plate 200.

When the vibration plate 200 has a track shape, it is preferred that the motion part 400 also has a track shape. If a conventional circular shaped motion part such as a circular bobbin is provided in the track shaped vibration plate 200, the motion part 400 is connected to a center of the track shaped vibration plate 200, which may cause a resonance mode of the vibration plate 200. Thereby, in the trade shaped vibration plate with the circular shaped motion part, an unintended vibration mode may occur and also a driving force for vibrating the vibration plate 200 may decrease.

Meanwhile, if the motion part 400 is track shaped, a width part 420a of the motion part 400 could be distorted and then it is difficult to actually embody the track shaped motion part 400. The thickness of the motion part 400, especially the thickness of the bobbin 420, is thin. Thereby, the width part 420a of the bobbin 420 may be distorted by the operation and inner heat of the speaker. Accordingly, a fastening part 230 is provided in the present invention and the fastening part 230 is projected downwardly from a back surface of the vibration plate 200 to prevent the distortion of the motion part 400. The motion part 400 is fastened to the vibration plate 200 by the fastening part 230 to reinforce the motion part 400.

The technical feature of using the fastening part 230 may be adapted to a circular type speaker, even though it is preferably adapted to the track type speaker.

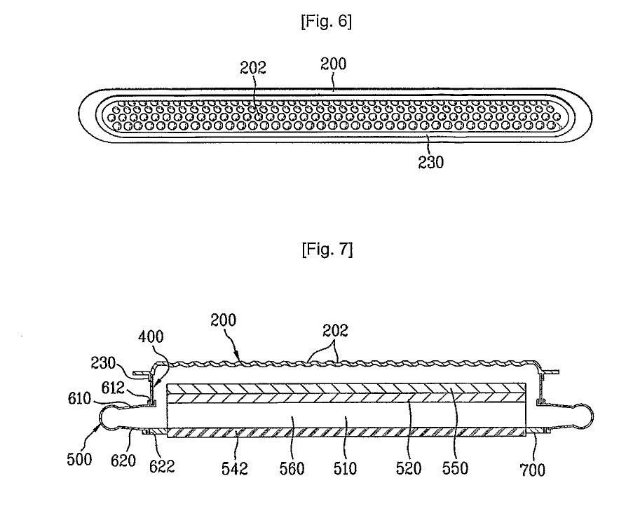

Referring to FIGS. 5 and 6, the vibration plate 200 will be described in detail.

The area enlargement part 202 is provided on the vibration plate 200 to enlarge the effective area of the vibration plate 200. The area enlargement part 202 may be embodied in a concave or convex shape such as a dimple or embossing. Alternatively, the area enlargement part 202 may be formed by appropriately combining the concave and convex parts.

A fastening part 230 is provided on a back surface of the vibration plate 200. The fastening part 230 is a portion where the vibration plate 200 is fastened to the bobbin 420. Due to the fastening part 230, the fastening structure between the vibration plate 200 and the bobbin 420 is reinforced and work efficiency is enhanced. Preferably, the area enlargement part 202 and the fastening part 230 are injection molded as one body with the vibration plate 200.

Accordingly, the effective area of the vibration plate 200 can be enlarged by the area enlargement part 202 and also the distortion of the bobbin 420 can be prevented by the fastening part 230 of the vibration plate 200.

Referring to FIG. 7, the fastening structure between the bobbin 420 and the vibration plate 200 will be described.

The fastening part 230 is provided on a back surface of the vibration plate 200. It is preferred that the appearance of the fastening part 230 corresponds to that of the bobbin 420, especially, a sectional view of the bobbin 420. It is also preferred that the fastening part 230 may be provided at an edge of the vibration plate 200. Alternatively, the fastening part 230 may be provided only a predetermine portion of the edge. For example, a plurality of small sized fastening parts may be provided, each of which is spaced apart at a predetermined distance.

The fastening part 230 may be formed in an approximate rectangular or oval shape and downwardly projected. That facilitates the bobbin 420 to be fastened to an inner portion of the fastening part 230 easily. Although not shown in the drawings, the bobbin 420 may be fastened to an outer portion of the fastening part 230 and also the fastening part 230 may be a pair of vertical protrusions. Then, an upper portion of the bobbin 420 is insertedly fastened between the pair of vertical protrusions.

The shape of the vibration plate 200 may not be limited to the above embodiment and then may be variable such as a plate type, cone type or the like. Although the track shaped vibration plate 200 and bobbin 420 are shown and described in the above embodiment, the present invention may not be limited thereto and accordingly may be adaptable in various ways. For example, in case of a speaker having a track shaped vibration plate/a circular bobbin or a circular vibration plate/a circular bobbin, an area enlargement part and a fastening part may be formed to enlarge an effective area of a vibration plate and to prevent distortion of a bobbin.

Next, referring to FIGS. 4 to 7, the fastening structure between the bobbin 420 and the damper 600 will be described.

When the track shaped vibration plate 200 and bobbin 420 are provided, there is little space in a width direction. Thus, according to the present invention, the damper 600 supports the vibration plate 200 only in a length part 420b (see FIG. 4). Distinguishably different from the prior art, the damper 600 of the present invention is connected only to the length part 420b of the bobbin 420. Preferably, the damper 600 is not plate shaped but curved or stepped bent in pairs.

More specifically, the damper 600 includes a first member 610 connected to an end of the length part 420b of the bobbin 420 and a second member 620 connected to the base frame 700. The first member 610 extends outwardly with respect to the second member 620. The second member 620 extends inwardly from the first member 620. It is preferred that the second member 620 is stepped (bent) from the first member 610. This structure may enlarge the area of the damper 600, because the damper 600 of this invention is mainly configured in a longitudinal (length) direction of the speaker, which has a spare space.

A groove 612 may be formed on a side of the first member 610, where the bobbin 420 is fastened, to insert a lower portion of the bobbin 420 therein. A projection 622 may be downwardly projected from a side of the second member 620 to be inserted in the base frame 700.

Referring to the FIG. 4, an operation of the speaker according to the present invention will be described.

Once an electrical signal is applied to the voice coil 440, the voice coil 440 vertically moves. In other words, the voice coil 440 performs a piston motion in interrelation with the permanent magnet 560. Hence, the bobbin 420 connected to the voice coil 440 also vertically performs a piston motion and the vibration plate 200 connected to the bobbin 420 vertically performs a piston motion to vibrate.

At that time, the effective area of the vibration plate 200 may be enlarged by the area enlargement 202 of the vibration plate 200 and may suppress an unnecessary vibration mode of the vibration plate 200. Thus, sound reproduction efficiency, especially, base sound reproduction efficiency may be enhanced. Also, distortion of the bobbin 420 may be effectively prevented by the fastening part 230, such that strange sound generated by the distortion of the bobbin 420 may be prevented.

As described in the embodiment, it is preferred that the speaker of the present invention is adapted to a display apparatus such as a TV, a computer, a monitor and the like and it is not limited thereto. Alternatively, the speaker of the present invention may be adapted to other various kinds of apparatus.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The industrial applicability of the present invention is described in the disclosure of the invention.

First, since an effective area of the vibration plate is enlarged by an area enlargement part according to the present invention, an unnecessary vibration mode of the vibration plate may be suppressed. Thus, there is an industrial applicability that a high quality sound/high power speaker can be presented.

Furthermore, since a nonlinear vertical motion of the vibration parts caused by the high ratio of the length to the width of the track type speaker may be reduced in present invention, there is another industrial applicability that a high sound quality speaker can be presented.

Still further, there is a further industrial applicability that a supporting structure of a damper may be improved.

1. A speaker comprising:
a fixing part fastened to a base frame;
a motion part moved with respect to the fixing part by an electromagnetic force;
a vibration plate that vibrates in communication with the motion part; and
an area enlargement part provided on the vibration plate to enlarge an effective area of the vibration plate.

2. The speaker as claimed in claim 1, wherein the area enlargement part is configured with at least one of a concave part and a convex part.

3. The speaker as clamed in claim 1, wherein the vibration plate is formed in a track shape.

4. The speaker as claimed in claim 3, wherein the shape of the motion part is corresponding to the shape of the vibration plate.

5. The speaker as claimed in claim 1, further comprising a fastening part provided in a back portion of the vibration plate to be fastened to the motion part.

6. The speaker as claimed in claim 5, wherein the fastening part is provided at an edge of the vibration plate.

7. A speaker comprising:
a fixing part fixed to a base frame;
a motion part moved with respect to the fixing part by an electromagnetic force;
a vibration plate that vibrates in communication with the motion part; and
a fastening part provided in a back portion of the vibration plate to be fastened to the motion part.

8. The speaker as claimed in claim 7, wherein the vibration plate is formed in a track shape.

9. The speaker as claimed in claim 8, wherein the shape of the motion part is corresponding to the shape of the vibration plate.

10. The speaker as claimed in claim 7, wherein the fastening part is provided an edge of the vibration plate.

11. The speaker as claimed in claim 10, wherein the fastening part is partially provided at the edge of the vibration plate.

12. The speaker as claimed in claim 8, wherein the fastening part is fastened to at least one of an outer surface and an inner surface of the motion part.
